(19) United States
(12) Patent Application Publication
(10) Pub. No.: US 2014/0047783 A1
(43) Pub. Date: Feb. 20, 2014

(54) WINDOW WITH MODIFIABLE TRANSPARENCY

(71) Applicant: Hanoch SHALIT, Nicosia 2006 (CY)

(72) Inventor: Hanoch SHALIT, Nicosia 2006 (CY)

(21) Appl. No.: 13/586,906

(22) Filed: Aug. 16, 2012

(51) Int. Cl. E04C 2/54; G02B 5/00

(52) U.S. Cl. 52/171.3

(57) ABSTRACT

A window with modifiable transparency, the window including window panes that define at least one cavity in between the panes. The window also including one or more mechanisms for introducing and removing a transparency modifying fluid into and from said one or more cavity.

### FIELD OF THE INVENTION

The present invention relates to systems controlling light and heat passage through a transparent medium, such as a window, door, or partition and the like.

### BACKGROUND OF THE INVENTION

The past few decades have seen widespread use of multilayer window glass panes to meet growing demands for air-tight, thermally insulated houses. Performance multilayer glass panes are typically used for the purpose of increasing thermal insulation. In order to provide privacy clear (transparent) glass may be made matte or translucent using high pressure sanding methods or chemical etching techniques. Liquid crystal display (LCD) panel systems and methods may be used to achieve translucent glass at will (e.g., at the push of a button).

These active systems require electric circuitry to provide energy to the system to modify the properties of an internal material within the system, and the optical properties of the whole system. These systems further typically require sophisticated production methods and equipment, resulting in a final product that is expensive to produce, install, and use. In addition, these systems may be subject to size limitations, e.g., they cannot be produced above a certain size, and the size has to be predetermined during production and cannot be modified by the installer at the customer site.

To save energy costs windows may reduce the light and heat energy passing through to an interior. In some embodiments, heat reflecting glass panels, e.g., panels that include one or more layers of a metal oxide, a metal, and a metal nitride on a transparent glass sheet, may reduce air-conditioning system loads. These heat reflecting glass panels may be effective in reducing air-conditioning system load through good sunlight shielding performance (e.g. triple silver layer low emissivity film structure). However, light shielding and transmission is constant—unaffected by the outside conditions and the customer's will.

Photochromatic materials may also reduce incoming light intensity; e.g., the use of silver halide materials within a medium of glass. Typically, when sunlight hits the silver halide crystals, it generates metallic silver from the silver ions, and turns the crystals from a transparent medium to black, effectively darkening the glass in the process. This process is reversible. Photochromatic systems are typically expensive to produce and typically do not allow modification of light intensity by the consumer: light itself activates the process and the medium darkens proportionally to the amount of light energy illuminating it.

### SUMMARY OF THE INVENTION

It is therefore an object of the present invention to provide a window with modifiable transparency.

The window may allow control and modification of light and heat properties in a medium such as a partition, window or a door. To allow alteration of light properties, at will, from a clear transparent medium, through which the image of the scenery through the medium is clearly visible, to, for example, a translucent medium where the light from the image is scattered such that the image cannot be clearly seen, or, in another example, to a reduced transmission of the light (or heat or other radiation) passing through.

Some embodiments of the invention may include a window with modifiable transparency. The window may include window panes, the panes defining at least one cavity in between the panes.

The window may further include one or more mechanisms for introducing and/or removing a transparency modifying fluid into and from said one or more cavity.

In some embodiments of the invention, the transparency modifying fluid may be opaque.

In some embodiments of the invention, the transparency modifying fluid may be translucent.

In some embodiments of the invention, the transparency modifying fluid may be reflective.

In some embodiments of the invention, the transparency modifying fluid may be nontransparent.

In some embodiments of the invention, the transparency modifying fluid may be in a compressed state.

In some embodiments of the invention, the window may also include a pump mechanism for introducing and removing a transparency modifying fluid into and from or more cavities.

In some embodiments of the invention, at least one cavity is at least partially reflective to radiation in a selected spectral region.

In some embodiments of the invention, at least one cavity contains a fluid that is different than a fluid contained in at least another one of a plurality of cavities.

In some embodiments of the invention, the window panes may be arranged parallel to one another.

In some embodiments of the invention, the window panes may be arranged non-parallel to one another.

In some embodiments of the invention, the at least one cavity has one or more walls, the walls may include a transparent material selected from the group of transparent materials consisting of glass, polymer, Polyester, resin, and air.

In some embodiments of the invention, at least one of the transparency modifying fluid may be spectrally selectively transmissive to light or heat.

In some embodiments of the invention, the window may include a seal.

In some embodiments of the invention, the seal may include a sealing material selected from the group of sealing materials consisting of: glue, rubber, latex, resin, silicone, polymer, and nylon.

In some embodiments of the invention, the transparency modifying fluid in at least one of the cavities may be translucent, and the transparency modifying fluid of another cavity may be opaque.

In some embodiments of the invention, at least two cavities may be filled such that their optical properties are substantially identical to one another.

In some embodiments of the invention, at least two cavities may be filled such that their optical properties are substantially non-identical to one another.

In some embodiments of the invention there may be a pattern within the cavity allowing for different fluids to be distributed within the cavity.

In some embodiments of the invention the transparency modifying fluid may be configured to affect and control heat transmission, absorption or reflection.

In some embodiments of the invention, the transparency modifying fluid may be in gaseous state.

In some embodiments of the invention, the window may include a floater.

In some embodiments of the invention, the window may include one or a plurality of reservoirs to contain the transparency modifying fluid.

In some embodiments of the invention, the window may include a control unit for introducing and removing the transparency modifying fluid.

### BRIEF DESCRIPTION OF THE DRAWINGS

In order to better understand the present invention, and appreciate its practical applications, the following Figures are provided and referenced hereafter. It should be noted that the Figures are given as embodiments only and in no way limit the scope of the invention. Like components are denoted by like reference numerals.

FIG. 1 depicts a schematic illustration of two glass panes of a window with modifiable transparency according to an embodiment of the present invention. The window may include spacers in between the glass panes that may provide the sealing of the interior volume;

FIG. 2 depicts a schematic illustration of a sealed volume, e.g., a cavity, within a window with modifiable transparency, according to an embodiment of the invention;

FIG. 3 depicts a schematic illustration of two reservoirs of dark and/or opaque ink configured to allow for the passage of the ink through a pump into a cavity in a window with modifiable transparency, according to an embodiment of the invention;

FIG. 4 depicts a schematic illustration of a window with modifiable transparency in a translucent state, according to an embodiment of the invention;

FIG. 5 depicts a schematic illustration of a window with modifiable transparency configured to selectively reflect incident radiation, according to an embodiment of the invention;

FIG. 6 depicts a schematic illustration of a window with modifiable transparency configured to fully reflect incident radiation, according to an embodiment of the invention; and,

FIG. 7 depicts a schematic illustration of a window with modifiable transparency with an additional ink reservoir, according to an embodiment of the invention.

### DETAILED DESCRIPTION OF EMBODIMENTS

In some embodiments, a system for controlling light and heat in a partition, door or a window (hereinafter, window), according to embodiments of the present invention may include multiple transparent layers coupled to form a window. Transparent layers may be transparent to one or a plurality of forms of radiant energy including light and/or heat. Transparent layers typically have a property related to the transparency to radiant energy. Typically, such system may include between 2 and 6, or more transparent layers.

In some embodiments, the window may have two larger, and in some examples, dominant, layers forming a window pane-like appearance and providing for an interior. In some embodiments, the window may include other layers, the other layers may be configured to connect and seal the interior part of the two dominant layers.

In some embodiments, two dominant layers are the only layers in the window, forming a window pane-like appearance, and those layers may be configured to connect and seal the whole interior box, and in some examples, a cavity within.

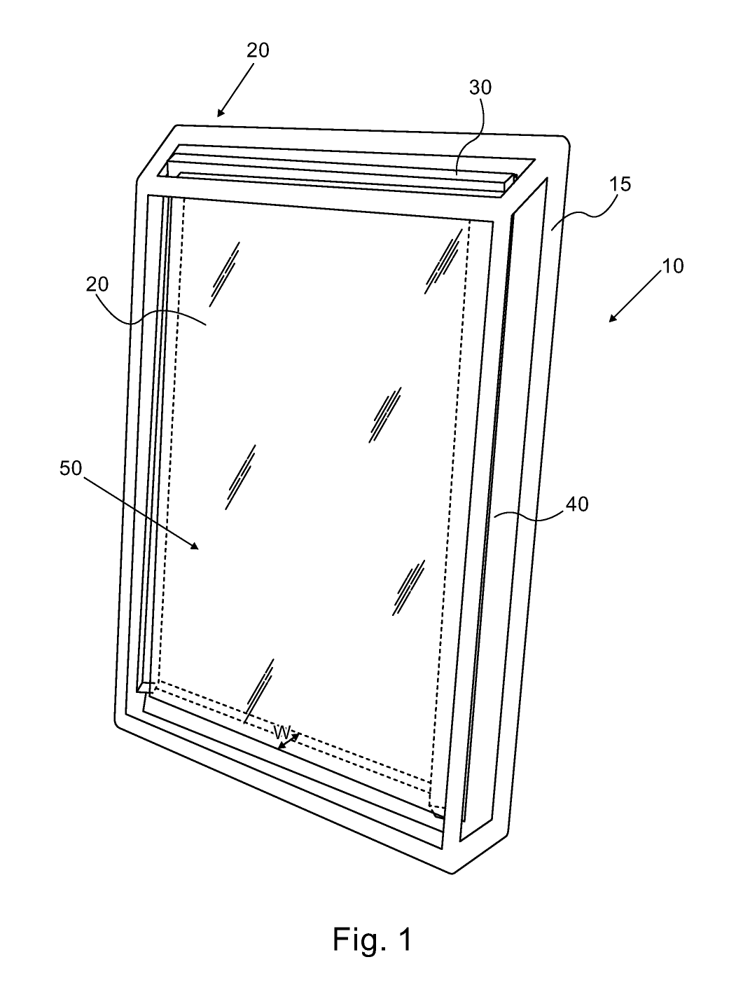

FIG. 1 depicts a schematic illustration of two glass panes of a window with modifiable transparency according to an embodiment of the present invention. The window may include spacers in between the glass panes that may provide the sealing of the interior volume.

The schematic illustration indicates one or a plurality of layers of parallel placed transparent glass, e.g., window panes. The window panes within a window, configured to modify the characteristics of the light and heat passing through the window, according to an embodiment of the present invention with spaces and sealers in the window.

In some embodiments, window 10 may be an exterior or interior window of a structure. In some embodiments, window 10 may form a partition within the interior of the building, such as a cubicle in an office. In some embodiments, window 10 may be used as a partition wall, for example, between a conference room and a corridor. In some embodiments, window 10 may be configured to be used as a door. In some embodiments, window 10 may be used as a skylight pane or a shop window or another window.

Window 10 may be used in sunglasses, crash helmets, or car windows, where the window may be curved, arched wavy, and/or otherwise not flat. In some embodiments, an activation of the transparent properties of window 10 may be made by a user, manually, by a controller, control unit, or by using a remote control or by one or a plurality of heat and/or light sensors activating one or a plurality of pumps, as described below.

Light transmission, typically light transmission into a structure such as a home, commercial, industrial or other structures may be modified by window 10. Window 10 may be configurable to have variable transparency properties, the variable transparency properties including reflectivity, opacity, absorbency and other properties.

Window 10 may include at least two window panes 20, the window panes typically glass, plastic or other transparent material. Window 10 may include a sealing frame 30, the sealing frame configured to encompass the perimeter of window 10 and provide for a sealed volume in one or a plurality of cavities 40 between window panes 20. Cavity 40 may have width W. Window 10 may have a frame 15.

Typically, light and heat, and other forms of radiation may pass through a window. Light and heat radiation may pass through, via light and heat transmission, when window 10 is transparent. In some embodiments, when window 10 is transparent, it is transparent to at least part of the visible spectrum, e.g. window 10 may include spectrally selectively transmissive materials such as tinted or colored transparent materials.

Cavity 40 between the glass panes 20 may be temporally, selectively, partially, and/or wholly filled with a fluid, e.g., where the fluid may be a liquid or a gas 50 that may render the window nontransparent or partially transparent. In some embodiments, when window 10 is nontransparent it may be opaque (i.e., typically reflecting or absorbing parts of the electromagnetic spectrum) to a region of the electromagnetic spectrum which the transparent region may otherwise typically transmit. Window 10 may be translucent or partially translucent (matte, textured, or scattering) to a region of the electromagnetic spectrum which the transparent region may otherwise typically transmits.

Typically, window 10 may be made nontransparent by the incorporation of materials into one or more cavities 40 such as a fluid, e.g., a liquid and/or gas. These materials may include, but are not limited to an etched transparent material, a polymer, a painted transparent material, ink deposited on a transparent material, a lamination layer, a metal, and a deposited metal layer, dyes pigments, inks, and chemicals that affect various part of the electromagnetic spectrum. Liquid or gas 50 may be colored gases that can absorb or reflect sections of the electromagnetic spectrum.

In some embodiments, when window 10 is nontransparent, window 10 may be reflective to all or some of the visible and/or heat spectrum. Typically, materials may be put into or added to cavity 40 to affect the transparent and nontransparent nature of window 10, modifying the transmission properties of window 10.

In some embodiments, cavity 40 may include a fluid, e.g., liquid or gas 50 that may alter the refractive index of window 10, or have absorption in part of all of the visible spectrum, or in the heat spectrum. The light absorption of the materials may be modified, in some instances, by varying the concentration of the light absorbing substances incorporated into the liquid or gas, such as dyes, pigments, or other materials.

In some embodiments, concentration and other parameters of liquid or gas 50 in cavity 40 can be chosen by a user or someone else to affect, in addition to their light absorption, scattering and reflection, also the viscosity, boiling and freezing points, adhesion to glass, surface tension, and other physical parameters that may affect the liquid or gas 50.

In some embodiments, a first cavity 40 may be filled with a liquid or gas 50 and/or other materials, and a second cavity 40 may be filled with a liquid or gas 50 and/or other materials such that the two filled cavities have optical properties that are the same or substantially similar to each other. In some embodiments the cavities may be wholly or partially overlapping within window 10. In some embodiments the cavities may be non-overlapping within window 10.

In some embodiments, one cavity 40 may be filled with a liquid or gas 50 and/or other materials, and a second cavity 40 may be filled with a liquid or gas 50 and/or other materials such that the two filled cavities have optical properties that are different and/or substantially dissimilar to each other. In some instances, the optical properties may include the absorption or reflection of the region of the electromagnetic spectrum, or in the state of the material within the cavity, the viscosity of the material within the cavity or other measures of similarities or differences.

In some embodiments frame 30 may encompass glass panes 20 with a seal. The seal may be tight or in some instances, airtight. In some embodiments cavity 40 in window 10 may typically be from 0.1 to 50 mm wide where the width of the cavity may be indicated by W in the schematic illustration.

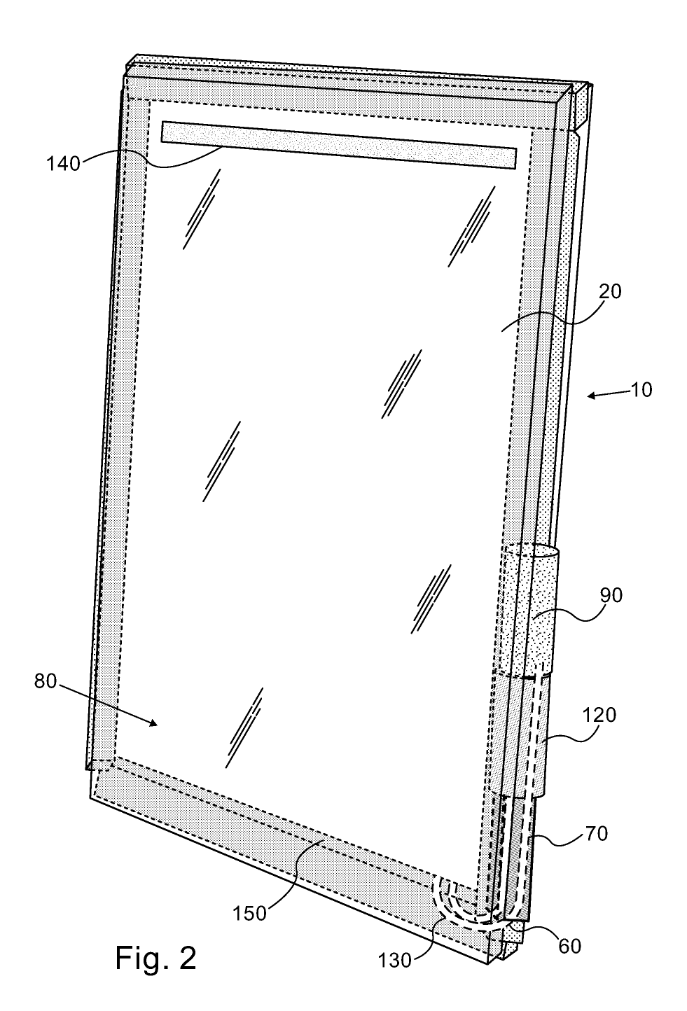

FIG. 2 depicts a schematic illustration of a sealed volume, e.g., a cavity, within a window with modifiable transparency, according to an embodiment of the invention.

The schematic illustration depicting one or a plurality of glass panes within a window frame, the window as drawn, is for illustrative purposes, and may or may not be similar or the same as the window described above in FIG. 1.

In some embodiments, liquid or gas 50 may be introduced and/or removed from cavity 40 via pipes 60 and/or pipes 130, typically via a pumping action as the result of one or more pumps 70, e.g. an electric pump or other pump mechanism. In some embodiments other methods and apparatuses may be employed to move liquid or gas into and or out of cavity 40 including, for example, pipes, a magnet, an electromagnet, an electric motor, a piezoelectric motor, a bimetallic strip, and a spring, as are known in the art for use in a pump, typically a manual or electric pump. Typically, pipes 60 direct the liquid or gas 50 to one or a plurality of parts of one or a plurality of cavities 40.

Liquid or gas 50 may be directed to a bottom portion 80 of window 10 such that liquid or gas 50 rises from bottom portion 80 when liquid or gas 50 fills up cavity 40. Liquid or gas 50 may also exit cavity 40 via the same pipes 60 and pump 70, back into a reservoir 90. Reservoir 90 may be located within frame 30, described above, of window 10.

Pump 70 may be a manual pump and may be operated by squeezing a flexible reservoir, e.g., reservoir 120, the flexible reservoir containing liquid or gas 50. In some embodiments, pump 70 may be designed to be able to pump in and out of window cavity 40 one or more types of liquid or gas 50 sequentially, i.e., pump in one liquid or gas 50, than pump it out, and then pump in another liquid or gas 50. In some embodiments, multiple pumps 70 may be used, each pump 70 pumping one type of liquid or gas 50. In some embodiments, a pump 70 may be configured to contain a cleaning fluid, or other fluid to clean window 10 internally between panes 20, so as to clean and clear the window of potential obstructions to viewing.

Liquid or gas 50 may be kept, maintained, held, or otherwise found within a reservoir, e.g., reservoir 90, the reservoir being located, for example, near pump 70, and in some embodiments, instead of pump 70. Liquid or gas 50, when located in the reservoir may be in a compressed state and/or form and configured to be released in the appropriate amount to render the required change in the window transmission.

In some embodiments, glass panes 20 may be made, or coated with material that wholly or partially repels an optically modifying material, e.g., the dark liquid or gas or the transparent and/or translucent liquid or gas so as to not allow the optically modifying material to stick to cavity walls, e.g., dominant layers forming a window pane 20, of cavity 40.

In some embodiments, a hydrophobic coating on the interior side of one or more glass panes 20 may wholly or partially repel a water based liquid or gas and prevent the water based liquid or gas from sticking to the sides of glass panes 20, or other material.

An interior of cavity 40 may be filled with a reflective liquid or gas. Typically, the reflective liquid or gas can be an intrinsic reflective material, such as mercury, or other liquid or gas in which reflective material can be incorporated to wholly or partially reflect the incoming light. In some embodiments, the reflective material to be incorporated into the liquid or gas may be solids that can reflect light such as gallium, mercury, and/or other metal compounds, glass bids, glass powder, titanium dioxide, mica, or other materials.

In some embodiments, reflective material to be incorporated into the reflective liquid or gas may be a chemical substances that dissolve in the liquid or gas to render it wholly or partially reflective, such as suspension of iron and/or silver nanoparticles in ethylene glycol Typically, the reflective liquid or gas may have a visible light and heat reflectance ranging from 10% to 100%, e.g., from 70% to 100%.

Cavity 40 may be empty, e.g., may be a vacuum or empty of gas or liquid 50, or may be filled with colorless transparent liquid or gas, configured to provide a clear view of the image beyond window 10.

Window 10 may be filled with the translucent liquid or gas, providing for light to enter a room interior from the outside, but not a clear image of the outside or a clear image of the inside. Typically, window 10 may be filled with the translucent liquid or gas such that it is configured to provide privacy.

In some embodiments, window 10 may be filled with reflective liquid or gas, configured to provide for light and heat to reflect back to the building exterior and configured to limit the amount of light and heat from entering a building or room interior from the outside. Typically, window 10 may be filled with the reflective liquid or gas such that it is configured to provide privacy shading, and cooling.

In some embodiments, window 10 may be filled with a reflective liquid or gas 50, configured to provide for light and heat to reflect back to the building or room interior and configured to limit the amount of light and or heat from leaving the building or room interior to the building exterior.

The colors of a transparent liquid or gas 50 and of the translucent liquid or gas 50 may be the same or similar. In some embodiments, the colors may be dissimilar. Typically, the transparent or translucent liquid or gas 50 may be of any color depending on the materials that are incorporated into the liquid or gas 50, such as dyes, pigments or the basic color of the intrinsic liquid or gas. In some embodiments, the color of a reflecting liquid or gas 50 may be modified by incorporating dyes and pigments.

In some embodiments, a reflective liquid or gas 50 may be pumped into window 10 when the window is placed in areas that face the sun so that it may reflect, rather than absorb, the incoming energy, reducing the heat load on building interiors.

Typically, a floater 140 on the top surface of liquid or gas 50 (typically liquid) may be configured to reduce evaporation, to affect surface tension of the liquid, and/or to enhance the uniformity of the liquid or gas rising from the bottom of cavity 40 and in some instances, may be incorporated into the window cavity. Floater 140 may be of any buoyant material. When liquid or gas 50 is removed from cavity 40, floater 140 may remain at the bottom of the window, typically in a recess 150, the recess configured such that the floater remains out of sight, not obscuring the window view.

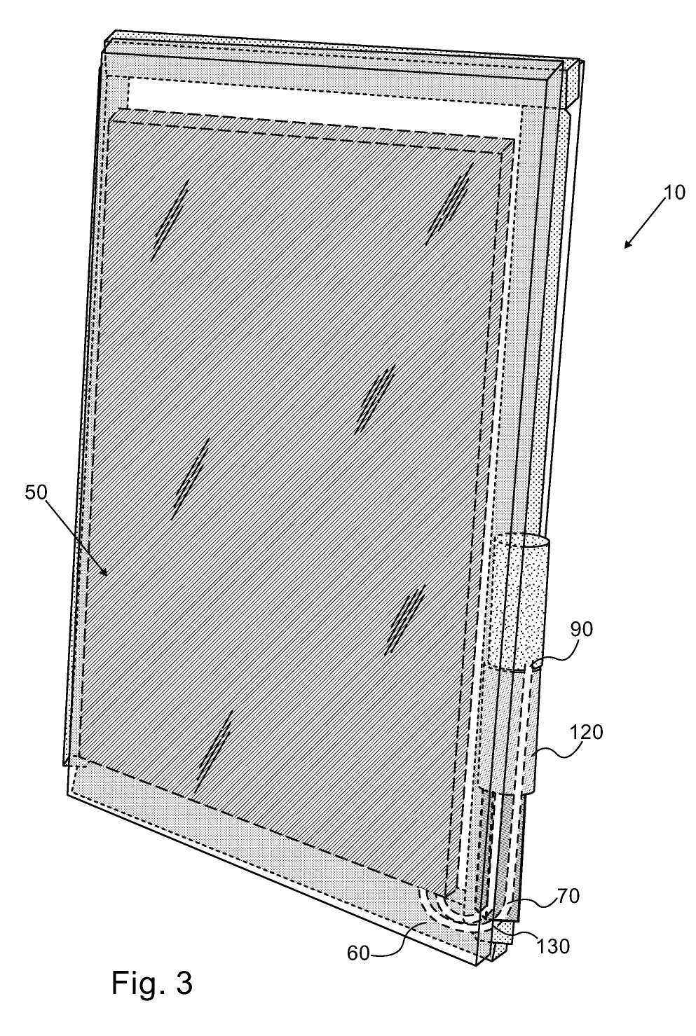

FIG. 3 depicts a schematic illustration of two reservoirs of dark and/or opaque ink configured to allow for the passage of the ink through a pump into a cavity in a window with modifiable transparency, according to an embodiment of the invention.

The window as drawn, is for illustrative purposes, and may or may not be similar or the same as the window described above.

The schematic illustration of a pumping system to introduce and/or remove a liquid or gas in and/or out of the window cavity. The pumping system may introduce and remove, or carry out either the introduction or the removal of a liquid or gas, e.g., a fluid into one or more cavities within the window, the window as drawn, is for illustrative purposes, and may or may not be similar or the same as the window described above.

In some embodiments, light does not pass through the window cavity and, typically, both heat and light may be absorbed by window 10.

Reservoir 90 may contain a gas or fluid to be pumped in to cavity 40 via pump 70. There may be a second reservoir 120. In some embodiments, there may be a plurality of reservoirs 90. Typically, pump 70 pumps liquid or gas 50 from reservoir 90 through pipes 60 into cavity 40. Reservoir 90 and 120 share pipes 60. In some instances reservoir 90 may be connected to pipes 60 and reservoir 120 may be connected to pipes 130.

In some embodiments, pump 70 may be a motor or similar device. There may be a plurality of pumps 70. In some instances, content within reservoir 90 and content within reservoir 120 may be pumped into cavity 40 by the same pump. In some embodiments, content within reservoir 90 and content within reservoir 120 may be pumped into cavity 40 by separate pumps.

As described below, a nontransparent material configured to be pumped into cavity 40 may be opaque or may block a significant amount of light. In some embodiments, transparent areas may be more transmissive of light than nontransparent (translucent or opaque) areas, but not necessarily transparent in the sense of a scene being readily viewable in an undistorted manner via the transparent areas.

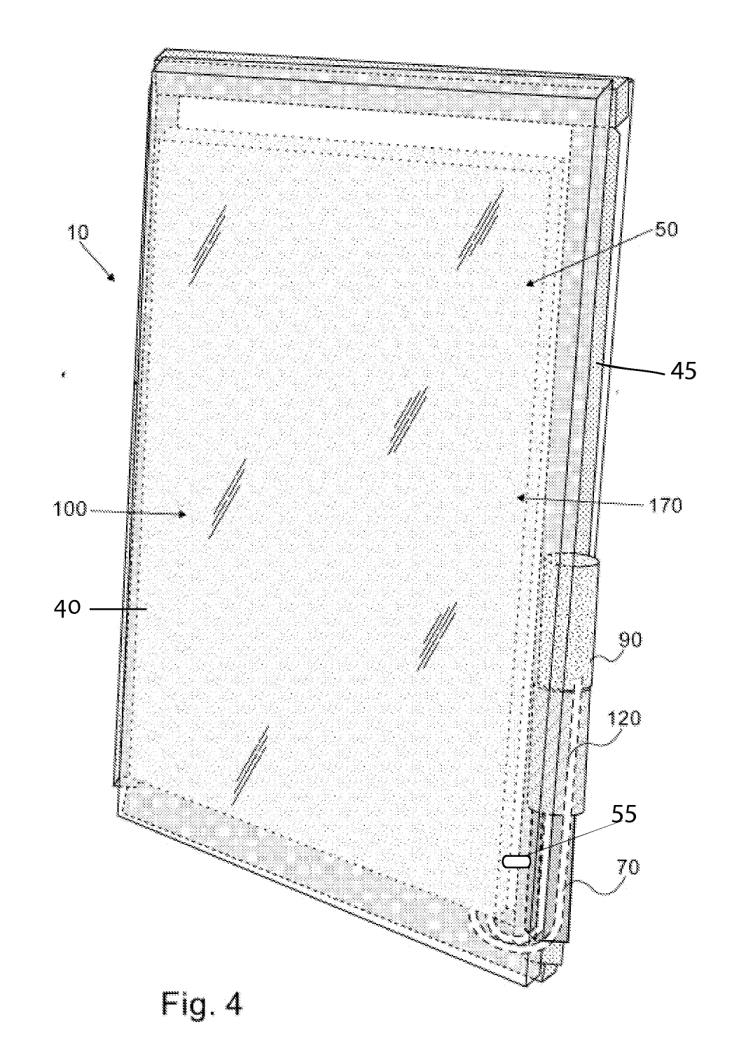

FIG. 4 depicts a schematic illustration of a window with modifiable transparency in a translucent state, according to an embodiment of the invention.

The schematic illustration of a window that may turn from transparent to translucent, according to an embodiment of the invention. The window as drawn, is for illustrative purposes, and may or may not be similar or the same as the window described above.

In FIG. 4 the cavity may change the optical and/or other characteristics of the window, or a portion thereof from transparent to translucent, according to an embodiment of the invention.

Window 10 may include a transparent sheet 100. Typically, transparent sheet 100 may be a transparent medium such as glass that is transparent or semitransparent in the visible light wavelength range, or, in some embodiments, a resin sheet, in some embodiments, a synthetic resin sheet, that is transparent or semitransparent in a visible light wavelength range. Other similar materials may also be used.

Typically, transparent sheet 100 may be made of float glass, soda-lime glass, borosilicate glass, crystallized glass, or other glass or similar materials. The resin sheet may be made of, for example, PET (polyethylene terephthalate), PVB (polyvinyl butyral), EVA (ethylene-vinyl acetate copolymer), or a cellulose resin.

Transparent sheet 100 may have a thickness ranging from 0.0001 to 50 mm, e.g., from 0.1 to 10 mm. Other dimensions may be used. Transparent sheet 100 may be an optically active substrate, e.g., a light polarizing material, a laminate of micro lenses, or ventricular system. Transparent sheet 100 may be capable of transferring image-forming light, mainly unaffected in some embodiments. Transparent sheet 100 may typically have a visible light transmittance ranging from 10% to 100%, e.g., from 70% to 100%. Transparent sheet 100 may include an add-on transparent medium 170 to a glass pane, e.g., glass pane 20, such as a synthetic resin laminate. The add-on medium may also be gelatin, polymethyl methacrylate (e.g. Plexiglas®), or when the overall structure is properly supported, air (e.g., a void).

Add-on transparent medium 170 may have a thickness ranging from 0 mm (absent, a clear empty window) to 10 mm, e.g., from 0 to 6 mm. Add-on transparent medium 170 may also be any non-transparent, e.g., translucent substrate that was made to be transparent in some of its areas, or was cut out of a translucent medium to make it transparent.

A first glass panes 20 may be substantially identical with a second glass pane 20 in window 10, with similar optical properties and include one or a plurality of transparent and one or a plurality of nontransparent regions. In some embodiments, the optical properties of the regions may differ from one another (e.g. differently sized areas or different spacing between areas). In some instances, the transparent and nontransparent regions in one region may be substantially identical to one another (e.g. same sized areas with identical spacing). In some embodiments, the transparent and nontransparent regions may differ from one another in size or spacing (e.g. one larger than the other). The optical properties may vary across the regions of the layer of glass panes 20.

In some embodiments, a dark liquid or gas 50, e.g., ink or other dark liquid or gas may be pumped into cavity 40 the dark liquid or gas may fill an internal volume of cavity 40, masking the view through window 10. In some instances, when a dark liquid or gas 50 is pumped out of cavity 40, window 10 will appear to be clear again, or in some embodiments, will provide a viewer with a mostly or totally unobstructed view through window 10.

In some embodiments, reservoir 90 may contain a dark liquid or gas 50 to be pumped in to cavity 40 via pump 70. There may be a second reservoir 120 with a second liquid or gas 50. There may be a plurality of reservoirs 90.

Typically, pump 70 pumps liquid or gas 50 from reservoir 90 through pipes 60 into cavity 40. Reservoir 90 and 120 may, in some instances, share pipes 60. In some embodiments, reservoir 90 may be connected to pipes 60 and reservoir 120 may be connected to pipes 130.

Pump 70 may be a motor or similar device, a more pump via a motor or a similar device. In some embodiments, there may be a plurality of pumps 70. Content within reservoir 90 and content within reservoir 120 may be pumped into cavity 40 by the same pump. Content within reservoir 90 and content within reservoir 120 may be pumped into cavity 40 by separate pumps.

In some embodiments a translucent window becoming transparent, according to an embodiment of the invention.

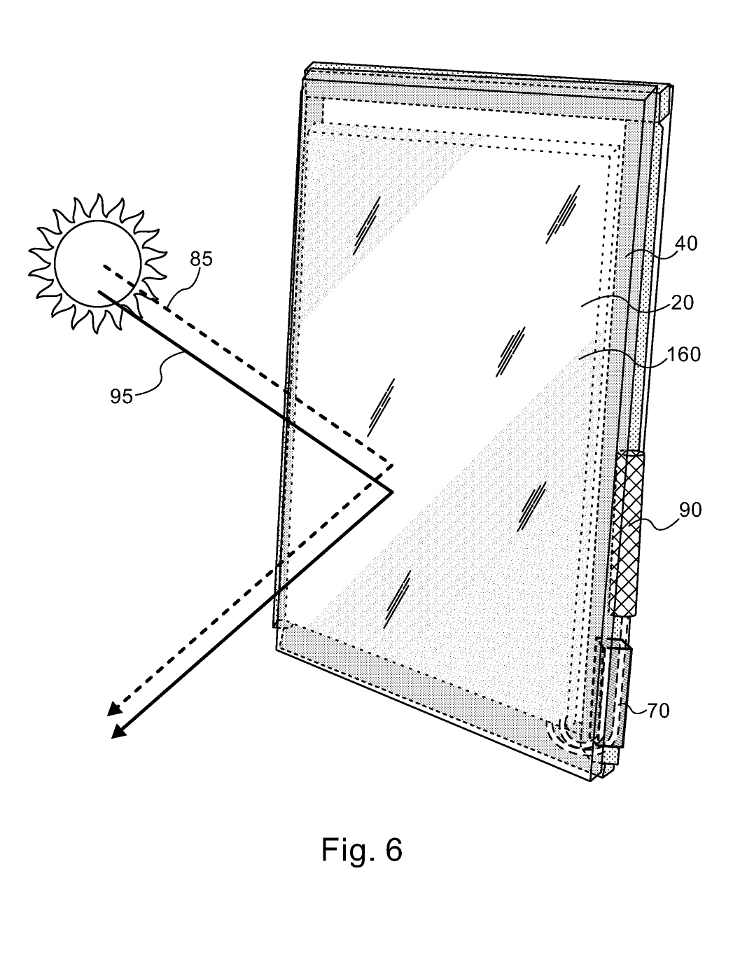

In some embodiments, a translucent medium may be included in window 10, e.g., a translucent sheet 160 as described and shown in FIG. 6. Translucent medium may be the substrate of a transparent sheet (e.g., glass), which was treated to become translucent, and may be capable of scattering the incoming image forming light, so as to scatter and diffuse the image so that it may not be clearly seen by the human eye. Translucent medium may have a visible light transmittance ranging from 10% to 100%, e.g., from 70% to 100%. Other ranges may be used.

Translucent medium may be the result of a treatment of the transparent sheet into the translucent state by, for example, chemical etching or sand blasting. Translucent medium may also be, for example, a transparent substrate that was made to be translucent in some portions thereof.

In some embodiments, when translucent medium or translucent substrate is included in window 10—the translucent medium or substrate or sheet typically rendering the window translucent, using liquid or gas of similar refractive index would allow the window to become transparent when the liquid or gas is introduced into the window cavity.

Translucent medium may be an add-on medium to the liquid or gas, such as a synthetic resin laminate. Translucent medium may have a thickness ranging from 0.01 mm to 10 mm, e.g., from 0.1 mm to 2 mm. Other dimensions may be used. Translucent medium may also be gelatin, Plexiglas® material, paper, polyester, photographic film, materials added by vacuum deposition, or sputtering techniques, and/or ink.

Window 10 may include a translucent sheet or translucent medium or translucent substrate (not shown). Typically, translucent sheet 160 may include a translucent medium such as glass that is translucent or semi-translucent in the visible light wavelength range, or, in some embodiments, a resin sheet, in some embodiments, a synthetic resin sheet, that is translucent or semi-translucent in a visible light wavelength range. Other similar materials may also be used.

Typically, translucent sheet may be made of float glass, soda-lime glass, borosilicate glass, crystallized glass, or other glass or similar materials. The resin sheet may be made of, for example, PET (polyethylene terephthalate), PVB (polyvinyl butyral), EVA (ethylene-vinyl acetate copolymer), or a cellulose resin.

Translucent sheet 160 may have a thickness ranging from 0.0001 to 50 mm, e.g., from 0.1 to 10 mm. Other dimensions may be used. Translucent sheet 160 may be an optically active substrate, e.g., a light polarizing material, a laminate of micro lenses, or ventricular system. Translucent sheet 160 may affect image forming light and may not allow an image, or in some embodiments a recognizable image, to be perceived through the window. However, when rendering translucent sheet 160 transparent, translucent sheet 160 will not adversely affect the image forming light. Translucent sheet 160 may typically have a visible light transmittance ranging from 10% to 100%, e.g., from 70% to 100%. Translucent sheet 160 may include an add-on translucent medium to a glass pane, e.g., glass pane 20, such as a synthetic resin laminate. The add-on medium may also be gelatin, polymethyl methacrylate (e.g. Plexiglas®), or when the overall structure is properly supported, air (e.g., a void).

The add-on medium may have a thickness ranging from 0 mm (absent, a clear empty window) to 10 mm, e.g., from 0 to 6 mm.

In this example, without the addition of liquid or gas 50 in cavity 40 the image seen through window 10 appears as a scattered image light, e.g., the discernability or clarity of the image that should be seen through window 10 is limited.

When liquid or gas 50 of a similar refractive index to the translucent medium or sheet 160, enters cavity 40, and comes in contact with an etched glass pane 20 or other etched glass surfaces, the liquid or gas 50 may smooth the etched glass pane 20 or other etched glass surface, changing the properties of glass pane 20 from one that scatters light into one that allows parallel light to pass through and become a discernable image to a viewer.

Typically window 10 is configured such that when liquid or gas 50 comes in contact with the translucent sheet, liquid or gas 50 may have limited contact, or no contact with a first side and/or facet of the translucent sheet. In some embodiments a second side of translucent sheet maybe flat and clear, e.g., not etched.

In some instances, a first and second side or facet of the translucent sheet may be etched when liquid or gas 50 enters cavity 40 from a first and a second side, e.g., in a case where there are at least a first cavity 40 and a second cavity 45 in window 10, with a common wall between the first and second cavity 40.

In some embodiments, a connecting pipe 55, depicted schematically in the figure for illustrative purposes, may be between cavity 40 and cavity 45 and/or between additional cavities. There may be additional connecting pipes 55. One or a plurality of connecting pipes 55 may be configured to assist in controlling the distribution of material, e.g., non-transparent material between cavity 40 and cavity 45, or other cavities. The controlled distribution may modify the radiation energy distribution within the window

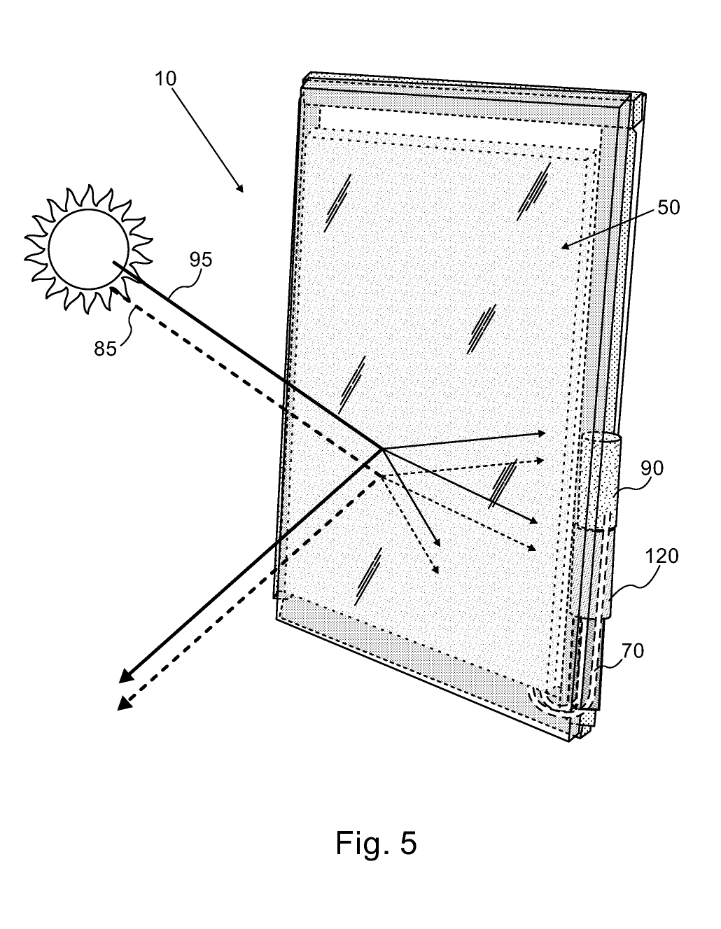

FIG. 5 depicts a schematic illustration of a window with modifiable transparency configured to selectively reflect incident radiation, according to an embodiment of the invention.

In some embodiments, as light passes through the window it may be scattered, providing a degree of privacy, according to an embodiment of the invention.

The figure schematically shows an illustration of the translucent material filling out the cavity in the window. In some embodiments of the invention, producing an unclear image. The window as drawn, is for illustrative purposes, and may or may not be similar or the same as the window described above.

In some embodiments, when a transparent and/or translucent liquid or gas 50 is pumped into cavity 40 in window 10, window 10 may become translucent, scattering the image light and producing unclear images when seen through window 10.

Light, depicted as arrow 95 and heat, depicted by arrow 85 may be partially absorbed and/or partially reflected, depending on the optical characteristics of liquid or gas 50.

In some embodiments, a translucent liquid or gas is pumped into cavity 40. The translucent liquid or gas may be a liquid or gas in which a translucent material can be incorporated to scatter the incoming light. Translucent material to be incorporated into the liquid or gas may be solids that can scatter light such as glass bids, glass powder, titanium dioxide, mica, or other materials.

In some embodiments, the translucent material to be incorporated with a liquid or gas may be chemical substances that dissolve in the liquid or gas to render it translucent, such as a substrate of a transparent sheet, which was treated to become translucent, and is capable of scattering the incoming image forming light, so as to scatter and diffuse an image so that it may not be clearly seen by the human eye. Typically, a translucent liquid or gas or a liquid or gas containing translucent material may have a visible light transmittance ranging from 10% to 100%, e.g., from 70% to 100%.

The transparent and/or translucent liquid or gas may include water, alcohol, benzene, or other clear liquid or gas which is transparent or semitransparent to the visible light wavelength range. In some embodiments, the translucent liquid or gas may be Polyacrylamide (poly(2-prop-enamide)), Polyaluminum chloride (PAC), flocculants, nanometer silicon dioxide dispersion, or any other translucent liquid or gas 50.

Typically, the transparent and/or translucent liquid or gas may be capable of transferring light and/or scattering image forming light. In some embodiments, the translucent liquid or gas may have a visible light transmittance ranging from 10% to 100%, e.g., from 70% to 100%. The transparent and/or translucent medium may be an add-on medium to the base liquid or gas, such as nanometer silicon oxide.

FIG. 6 depicts a schematic illustration of a window with modifiable transparency configured to fully reflect incident radiation, according to an embodiment of the invention.

In some embodiments, light, UV, IR, heat and other radiation from other sources of energy may be reflected providing shading, privacy and cooling, according to an embodiment of the invention.

The figure schematically illustrates an example of light and heat rays when interacting with a window filled with a translucent fluid. The window as drawn, is for illustrative purposes, and may or may not be similar or the same as the window described above.

There may be multiple cavities 40 created inside window 10, such that each cavity 40 may input and output a material of modifying optical properties of light and heat, so that a combination of these materials in the different cavities 40 will have the desired optical properties of the window. For example: one cavity 40 may be filled with heat absorbing, but light transmitting material that allow for light to be transmitted to the room interior, as well as heat.

In some embodiments, each or both of the applicable materials from cavities 40 that absorb heat and/or transmit light may be pumped into and out of cavities 40 by the user. In some instances, multiple cavities 40 may allow various combinations of colors or sections of the light or heat spectrum to pass through window 10, the various combinations of colors or sections of the light or heat spectrum passing through window 10 configured to change the light and room appearance.

Pump 70 may be configured to pump a material, e.g., mercury, into cavity 40. Pump 70 may be configured to pump material into cavity 40, such that cavity 40 reflects incoming light. A fraction of the incoming light may be reflected. In some embodiments, the reflective material, e.g., a reflective liquid or gas 50 may be made to be selectively reflective and absorbing to different regions of the incident spectrum: e.g., it may reflect the heat but absorb in the visible region of the spectrum reducing heat load but appearing colored or tinted to the human eye.

In some embodiments, selective reflective and absorbing properties of liquid or gas 50 may be designed to be visibly different to a human eye depending on the location of the viewer. For example, a viewer within an interior of a structure may view a reflective liquid or gas, the reflective liquid or gas configured to be mainly reflect heat and absorb one section of the visible section, e.g. absorb magenta, as appearing green. A viewer external to the structure in which window 10 is coupled may view the reflective liquid or gas, the reflective liquid or gas configured to be mainly reflect heat and absorb a different section of the visible spectrum, e.g. absorb yellow, as appearing blue. In some embodiments, an exterior facing glass pane 20 of window 10 may be configured to reflect the heat, cooling the interior of the building, while an interior facing glass pane 20 absorbs the room heat.

In some embodiments, light and heat may be selectively absorbed and/or reflected depending on the material filling cavity 40. In some embodiments, a translucent material or sheet 160 filling cavity 40 may reflect a majority of light and a majority of heat, absorbing a minority of heat and allowing a minority of light to pass through.

Translucent material may reflect a minority of light and a minority of heat, allowing a majority of the light to pass through window 10 and a majority of heat to be absorbed. Translucent material may reflect a majority of light and a minority of heat, allowing a minority of the light to pass through window 10 and a majority of heat to be absorbed.

In some embodiments, translucent material may reflect a minority of light and a majority of heat, allowing a majority of the light to pass through window 10 and a minority of heat to be absorbed. Translucent material may be configured such that other combinations of heat and light reflectance and absorbance and transmittal may also occur.

In some instances, an exterior facing glass pane 20 of window 10 may be configured to absorb the heat, heating the interior of the building, e.g., configured to warm the building interior, while an interior facing glass pane 20 reflects heat, back to the interior, e.g., configured to preserve heat.

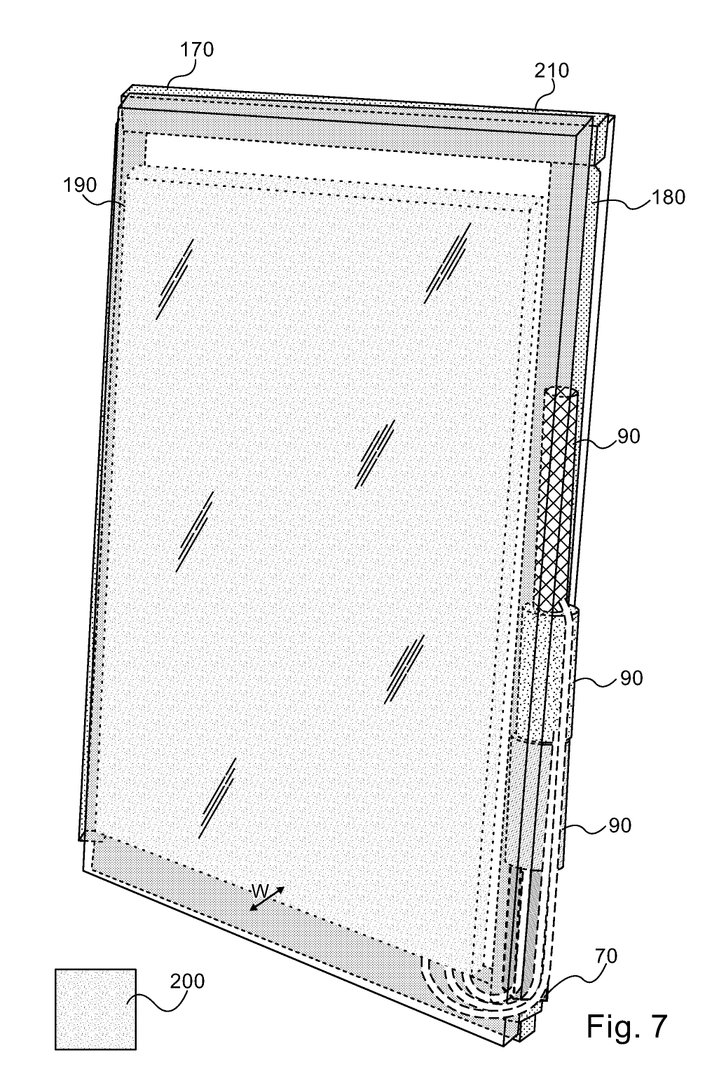

FIG. 7 depicts a schematic illustration of a window with modifiable transparency with an additional ink reservoir, according to an embodiment of the invention.

The window as drawn, is for illustrative purposes, and may or may not be similar or the same as the window described above.

The figure schematically illustrates of an example of one cavity within a window with a plurality of different reservoirs of liquid or gas materials that can absorb, scatter and reflect light and heat waves.

Three reservoirs are shown in the illustration for illustrative purposes only, fewer or more reservoirs may also be used.

Typically, pump 70 may be used to input and output a liquid or gas 50 into and out of cavity 40. One or a plurality of pumps 70 may be employed. In some embodiments, each reservoir 90 may be coupled to a unique pipe 60 to transport a material, e.g., a fluid, in the reservoir into cavity 40.

In some embodiments, one or a plurality of reservoirs 90 may be filled with high optical density material. Typically, the high optical density material may be ink, laminate, pigment, and/or paint of any kind. Different materials may be superimposed in window 10, the different materials pumped into distinct cavities 40.

In some embodiments, light, e.g., a low optical density, shading may be provided by materials that are not optically dense, the materials pumped in form a reservoir 90 into a first cavity 40; other cavities 40 in window 10 may have a higher optically dense material pumped in from a second reservoir 90. When both cavities 40 are filled, in this example, the optical density of the two cavities is combined to create a higher optical density window to a wavelength, e.g., a wavelength in the visible spectrum.

In some embodiments, when one cavity 40 is filled with material having a low optical density, e.g., 0.3 (transmitting 50% of the light) and a second cavity 40 is filled with a material with a higher optical density, e.g., 0.7, then window 10 transmission in this superimposed (combined) mode of the combined filled cavities is 1.0, or light transmission of about 10%.

In some embodiments, one or a plurality of cavities 40 of a multi-cavity window 10 may be partially filled, so as to allow for different areas of window 10 to pass different intensities of parts of the visible and heat spectrum. An opaque liquid or gas 50 may be pumped in via pump 70 into bottom of cavity 40, filling only a portion of the volume of a first cavity 40 and the visible area of cavity 40, and a liquid or gas 50 is pumped in via pump 70, or another pump, to fill an entirety or majority of a volume of a second cavity 40.

In some embodiments, when the first cavity 40 is half full and the second cavity 40 is full, a lower half of window 10 will typically be dark and cut the light intensity in the room to half, while an upper part of window 10 may allow light to pass through. Typically, the above example may be configured to provide privacy with the light coming through the top of window 10 being scattered.

In some embodiments, fluid of gas 50, including, in some instances, dense materials, may be configured to be spectrally selectively transmissive, e.g., tinted with various colors. This result in a change in color appearance of window 10 when one or a plurality of layers are moved, may allow for many possibilities of colored windows permutations.

Patterns may be incorporated into cavities 40, the patterns configured such that when changes in light characteristics occur; these changes may be viewed differently in window 10 from instances under different light characteristics. For example, when a liquid or gas 50 of a particular density fills an area, and is colored green, and a second optically dense liquid or gas 50 fills a second area, and is colored in red, one or a plurality of superimposed areas in window 10 may provide an appearance in that section that may appear to be very dark to the human eye, while the transparent areas, e.g., where optically dense fluid and or gas 50 are not filling cavity 40, may appear bright and neutral in color to the human eye. When the optically dense colorful areas move or are moved over the transparent areas, a portion or all of window 10 may have red and green areas in close proximity, which appears to a viewer as yellow.

In some embodiments, the use of reflecting material within one or more cavities 40 may prevent a high density material from heating substantially, thus eliminating or reducing a need to use double glazing to reduce heat transfer. In some embodiments, areas within window 10 containing high optical density fluids or gases may also be suitable to reflect heat energy, with reflection, in some embodiments, in the far, or thermal, infrared (IR) spectrum. In some embodiments, high optical density fluids or gases may have an optical density in the range of 0.1 to 10.0.

When heat reflecting material is used, it may be suitable for heat load reduction in a building when window 10 is placed in an exterior window and door panes in a building, in skylights or other areas. To further reduce the heat load, windows 10 may include a double glazing window system, where a vacuum or other medium insulate the building interior from heat absorbed by the heat absorbing layers in window 10.

In some embodiments, areas of window 10 containing fluids or gases 50 that are transparent or nontransparent may be configured to be spectrally selectively transmissive. For example, some areas of window 10 may transmit infrared or visible radiation while absorbing, scattering, or reflecting radiation of another selected spectral region.

In some embodiments, diffusing materials included in fluids or gases 50, the fluids or gases configured to make window 10 translucent, may incorporate heat reflecting materials that may reduce the heat load on the building interiors. Typically, an additional cavity 40 of a heat reflecting filled material may be filled with a liquid or gas 50 the liquid or gas 50 configured to make the additional cavity 40 appear transparent, or semitransparent, or a selective mirror, that may reflect the heat while allowing the light to pass on to the translucent layer behind.

The Width of cavity 40, W, described above with reference to FIG. 1 may be modified to be wider at a bottom of the window and narrower at a top of window 10, the narrowed width W configured to allow a lesser amount of liquid or gas 50 to be in an upper portion of cavity 40, e.g., near the top of window 10. Typically, when there is lesser amount of liquid or gas 50 in a portion of cavity 40, the portion with the lower volume may have a characteristic wherein it has less optical stopping power compared to another portions of window 10. When a first portion of window 10 has less optical stopping power than a second portion, the first portion may comparably provide for a higher passage of light and heat than the second portion.

Typically, when window 10 contains two portions, a first portion with comparably less optical stopping power, this may result in producing variable, gradient, in the optical properties of window 10.

In some embodiments, a variable volume of the liquid or gas 50 configured to be nontransparent can be used within the same cavity 40, allowing variable (and, in some instances, gradual) shading by the window. For example: a narrower width W configured to provided less volume at a bottom of cavity 40, compared to a top of cavity 40, may allow lower transmission of optical energy of the top of the window than the bottom. This may allow window 10 to mask or shade the sun when the sun is high in the sky, while, in some embodiments, e.g., in a tall structure, allowing unobstructed (or lightly shaded) viewing of a street below.

In some embodiments, one or a plurality of connecting pipes 55, described above may be between cavity 40 and cavity 45, cavity 45 described above, and/or between and/or connecting additional cavities. One or plurality of connecting pipes 55 may be configured to assist in controlling the distribution of material, e.g., non-transparent material between cavity 40 and cavity 45, or other cavities. The controlled distribution may modify the radiation energy distribution within the window

Windows 10 containing multiple cavities 40 may also be used to offer the user the choice of obtaining reduction in light intensity or increase in light scatter. For example, a window 10 may contain a first cavity 40 filled with a liquid or gas 50 that has high optical density and a second cavity 40 containing a liquid or gas 50 with translucent scattering properties. A user may be given a choice of filling up a first or second or another cavity 40. Filling up the first cavity 40 may result in reducing light intensity in a room. Filling the second cavity 40 may result in increased privacy for user on the interior.

A multi-cavity window may also be made using layers 170 of different material and thicknesses such as glass, Plexiglas® material, polyester films, photographic films, polyester film (e.g. Mylar® material), or polycarbonates. This may allow for less weight and thickness of a layer than if the layer were made of glass.

A multi-cavity window 10 may include double glazing glass panes 20. In some embodiments, one or a plurality of seals 180 may maintain the integrity of one or more cavities 40. Seals 180 may be made of, for example with glue. Seals 180 may include sealing materials including rubber, latex, resin, silicone, polymer, or nylon. Seals 180 may include other materials that may be capable of providing suitable protection against the elements and being flexible enough to absorb small movements of the glass that may be as small as 0.01 mm. Seals 180 may cover the gap between the panes from an outside of a structure containing window 180. A short distance movement of one pane over another could be accommodated by seals 180.

In some embodiments, glass panes 20, or other materials that form an exterior wall 190 of cavity 40 may be configured to expand or contract at a different rate than a second exterior wall of cavity 40, the expansion and/or contraction typically depending on temperature changes. In some embodiments, an exterior wall 190 may be made to move and increase a gap width W and a cavity 40 volume, by means of an apparatus (e.g., a bi-metal) that expands or contracts based on temperature. An exterior wall 190 may be made to move by means of an apparatus 200 that may be activated by light intensity (e.g., a photo detector) and/or activated by change in temperature (e.g., a heat-detector).

In some embodiments, one or a plurality of cavities 40 in a multi-cavity window 10 may not be parallel to each other, may be curved, or may form repeated characteristics.

An external wall 190 of cavity 40 may include areas that are cut out to make it change its optical properties.

A nontransparent liquid or gas 50, and/or a transparent liquid or gas 50 in one or a plurality of reservoirs 90 of cavities, or within a single cavity 40, may be composed of different materials. The different materials may enable providing the window 10 cavity 40 with variable optical density, privacy, or spectral transmission and reflection options (e.g. brighter and less transmissive of heat near the top, scattering for privacy at the bottom).

In a multi-cavity window 10, an exterior facing cavity 40 may be configured to contain high optical density fluids or gases 50 which may include a reflective material, and/or high optical density fluids or gases 50 configured to reflect light and heat, and a second, interior facing cavity 40 may be configured to contain different fluids or gases 50 of a different color (and texture). In some embodiments, high optical density fluids or gases 50 within exterior facing cavity 40 may be configured to simulate a one way mirror, so the window 10 appearance may be of minor from the outside, and dimmed image of the outside scenery from the inside of the building.

A multi-cavity window 10 may incorporate a dial button, switch, a lever, or electrical switch, and/or other device configured to input and output material into and out of the cavities 40.

In some embodiments, of a multi-cavity window 10, a layer 210 may be put over and/or between the exterior walls 190 of cavity 40. Layer 210 may be connected to exterior walls 190, and/or configured to cover a gap between the exterior walls 190. Layer 210 may be made of elastic material such as latex. It may be located in the areas covered by the window frame 15. Alternatively, if such layer is made of transparent material it may completely cover the whole panes and some or all the related equipment.

In some embodiments, of a multi-cavity window 10, one or more cavities 40 may have a pattern (created by adding or subtracting ink (optically modifying material) from the cavity volume) that may not be visible to a viewer when a liquid or gas 50 is either inside or outside of cavity 40 and may be revealed to the viewer during the transition to the an other state, e.g., when cavity 40 is either filled or emptied, due to the motion of a material within cavity 40. The pattern may be of any color, and combinations of colors can be made with patterns in different cavities in a multiple cavities system.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A window with modifiable transparency, the window comprising:
a plurality of static window panes disposed in a window frame, a portion of the window frame at least partially defining one or more fluid reservoirs, the window panes at least partially defining at least one cavity; and
one or more pumps configured to convey transparency modifying fluid between the cavity and the one or more fluid reservoirs.

2. The window of claim 1, wherein the transparency modifying fluid is opaque.

3. The window of claim 1, wherein the transparency modifying fluid is translucent.

4. The window of claim 1, wherein the transparency modifying fluid is reflective.

5. The window of claim 1, wherein the transparency modifying fluid is nontransparent.

6. (canceled)

7. The window of claim 1, wherein at least one cavity is at least partially reflective to radiation in a selected spectral region.

8. The window of claim 1, wherein the at least one cavity comprises a first cavity and a second cavity, wherein transparency modifying fluid associated with the first cavity has different transparency properties than transparency modifying fluid associated with the second cavity.

9. The window of claim 7, wherein the transparency modifying fluid associated with the first cavity is implemented as a gas and the transparency modifying fluid associated with the second cavity is implemented as a liquid.

10. The window of claim 1, wherein the window panes are arranged non-parallel to one another.

11. The window of claim 1, wherein the at least one cavity has one or more walls, the walls comprising a transparent material selected from the group of transparent materials consisting of glass, polymer, polyester, and resin.

12. The window of claim 1, wherein at least one of the transparency modifying fluid configured to be spectrally selective to control heat or light transmission, absorption or reflection.

13. (canceled)

14. The window of claim 1, wherein the transparency modifying fluid in a cavity of said at least one cavity is translucent, and the transparency modifying fluid in another cavity of said at least one cavity is opaque.

15. The window of claim 1, wherein said at least one cavity comprises a plurality of cavities, at least two cavities are filled such that their optical properties are substantially identical to one another.

16. The window of claim 1, wherein the pump is activated by a sensor.

17. The window of claim 1, wherein there is a pattern within the cavity allowing for different fluids to be distributed within the cavity.

18. A method of attenuating light in a window, the method comprising:
providing a plurality of static window panes disposed in a window frame, a portion of the window frame at least partially defining one or more fluid reservoirs, the window panes at least partially defining at least one cavity;
one or more pumps configured to convey transparency modifying fluid between the cavity and the one or more fluid reservoirs; and
using at least one of the pumps to convey transparency modifying fluid between the cavity and the reservoir.

19. The method of claim 18 wherein the transparency modifying fluid is selected from the group consisting of opaque fluid, translucent fluid, and reflective fluid.

20. The method of claim 18, wherein the transparency modifying fluid is implemented as a gas or a liquid.

21. The method of claim 18, wherein using at least one pump to convey transparency modifying fluid between the cavity and the reservoir includes conveying a plurality of transparency modifying fluids to respective cavities of the at least one cavity, each of the plurality of transparency modifying fluids having different transparency properties.

22. The method of claim 18, further comprising activating the pump with a sensor.
